(19) United States
(12) Patent Application Publication
(10) Pub. No.: US 2007/0167175 A1
(43) Pub. Date: Jul. 19, 2007

(54) Wireless virtual-network systems and methods to operate the same

(76) Inventors: Tony Wong, Dallas, TX (US); Xiaolin Lu, Plano, TX (US); Kush Parikh, Kirkland, WA (US)

Correspondence Address: TEXAS INSTRUMENTS INCORPORATED, P O BOX 655474, M/S 3999, DALLAS, TX, 75265, US

(21) Appl. No.: 11/333,016

(22) Filed: Jan. 17, 2006

(51) Int. Cl. H04Q 7/20

(52) U.S. Cl. 455/456.5

(57) ABSTRACT

Wireless virtual-network systems and methods to operate the same are disclosed. An example method comprises receiving a positioning system signal identifying a location of a mobile device, determining a service zone for the mobile device by comparing the location to a database identifying geographic locations of service zones, and determining a service parameter for the mobile device based upon the service zone.

### FIELD OF THE DISCLOSURE

This disclosure relates generally to wireless systems and, more particularly, to wireless virtual-network systems and methods to operate the same.

### BACKGROUND

Today, wireless services are based on at least one of a wireless basestation transceiver subsystem (BTS) identifier (e.g., a cell identifier) and/or a communication frequency (i.e., carrier frequency) used by the BTS. An example service provider provides a wireless telephone service where a billing and/or service rate for the telephone service depends upon the current location of a mobile device. For instance, when the mobile device is near the residence and/or place of business of the user of the mobile device, all telephone calls placed and/or received via the mobile device (e.g., local calls) are included in a service plan. However, calls placed when the mobile device is farther from the residence and/or place of business are charged long-distance service charges. The location of the mobile device is determined based upon cell identifiers (i.e., cell IDs). Thus, one or more BTSs form the local calling service area for the mobile device.

Another example service provider uses wireless technology to provide telephone services to residences, businesses, etc. via a mobile device, while restricting operation of the mobile device to an area near an assigned BTS. For instance, the provider may use BTSs having differing carrier frequencies and mobile devices that can communicate using only a single one of the carrier frequencies and, thus, each mobile device can communicate with only one of the BTSs. If the mobile device is not located in the relatively small area served by the BTS that uses the same carrier frequency as the mobile device, then the mobile device is no longer able to receive and/or place telephone calls.

In general, services and/or service areas for existing wireless systems are based on geographic areas served by particular BTSs. Further, the boundaries of the geographic service areas are determined by communication capabilities of the BTSs, that is, the size and/or shape of the area for which the BTS can communicate with mobile devices.

### BRIEF DESCRIPTION OF THE DRAWINGS

FIG. 1 is a schematic illustration of an example wireless system.

FIG. 2 illustrates an example manner of implementing the wireless mobile device of FIG. 1.

FIG. 3 illustrates an example manner of implementing the wireless basestation transceiver subsystem (BTS) of FIG. 1.

FIGS. 4 and 5 illustrate example wireless virtual-network service scenarios.

FIGS. 6 and 7 illustrate flowcharts representative of example machine readable instructions that may be executed to implement the example virtual-network service scenarios of FIGS. 4 and 5.

FIG. 8 is a schematic illustration of an example processor platform that may be used and/or programmed to execute the example machine readable instructions of FIGS. 6 and/or 7 to implement the example virtual-network service scenarios of FIGS. 4 and 5.

### DETAILED DESCRIPTION

Wireless virtual-network systems and methods to operate the same are disclosed. A disclosed example method comprises receiving a positioning system signal identifying a location of a mobile device, determining a service zone for the mobile device by comparing the location to a database identifying geographic locations of service zones, and determining a service parameter for the mobile device based upon the service zone. Another disclosed example method comprises determining a location with a positioning system receiver, sending a service request and an identification of the location to a wireless basestation transceiver subsystem (BTS), and receiving a service parameter associated with the service request from the BTS, wherein the service parameter is determined based upon the location.

A disclosed example apparatus comprises a database mapping service parameters to geographic locations, a service authorizer to receive location information from a mobile device and to access the database to determine a service parameter associated with the mobile device based upon the location information, wherein the location information is obtained via a positioning system receiver associated with the mobile device. The disclosed example apparatus further includes a baseband module to communicate the service parameter to the mobile device via a wireless signal.

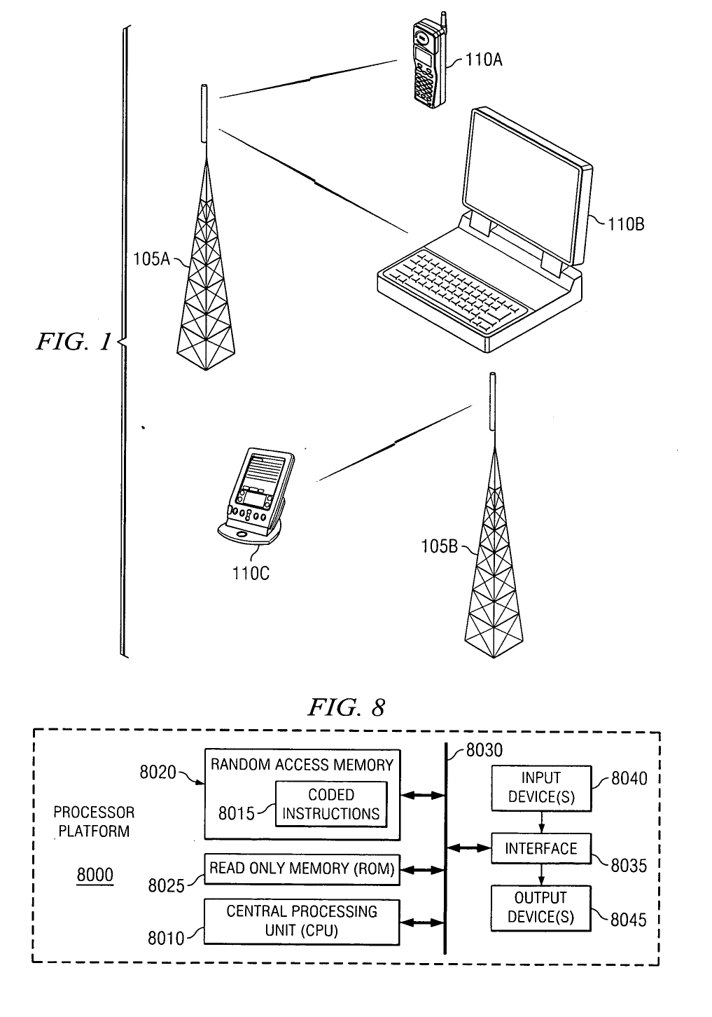

FIG. 1 is a schematic diagram of an example wireless communication system. To provide wireless communication services (e.g., telephone services, internet services, messaging services, video services, audio services, etc.), the example system of FIG. 1 includes of a plurality of wireless basestation transceiver subsystems (BTS) (two of which are designated in FIG. 1 with reference numerals 105A and 105B) that, using any of a variety of conventional devices and/or techniques, collectively provide wireless communication services over a geographic region. For example, the plurality of BTSs may be arranged in a grid with abutting and/or slightly overlapping coverage areas such that a mobile device moving through and/or within an area covered by the plurality of BTSs can, at all times, communicate with at least one of the BTSs.

The plurality of BTSs may provide the wireless communication services to any of a plurality of conventional mobile devices. Example mobile devices include a wireless telephone (i.e., cellular) 110A, a laptop computer 110B with wireless communication capabilities, a personal digital assistant (PDA) 110C, an iPod®, etc.

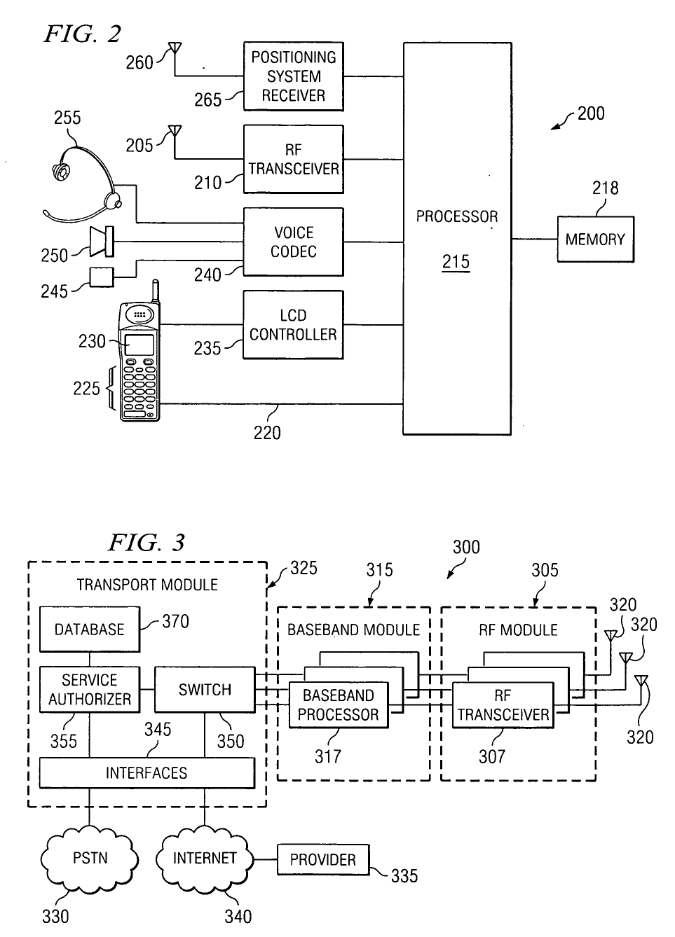

FIG. 2 illustrates an example manner of implementing at least a portion of any of the plurality of example mobile devices 110A, 110B and 110C of FIG. 1. To support wireless communications with a BTS (e.g., the BTS 110A of FIG. 1), the example mobile device 200 of FIG. 2 includes any of a variety of wireless antennas 205 and any of a variety of radio frequency (RF) transceivers 210. In particular, the antenna 205 and the RF transceiver 210 are able to receive, demodulate and decode wireless signals transmitted to the mobile device 200 by, for example, the BTS 110A. Likewise, the RF transceiver 210 and the antenna 205 are able to encode, modulate and transmit wireless signals from the example mobile device 200 to the BTS 110A.

To process received and decoded signals and to provide data for transmission, the illustrated example of FIG. 2 includes a processor 215. The processor 215 may be any of a variety of processors such as, for example, a digital signal processor (DSP) from the TI® family of DSPs, an OMAP® processor from TI, an advanced reduced instruction set computing (RISC) machine (ARM) processor, etc. To store data and/or machine readable instructions for the processor 215, the example device 200 includes a memory 218. In general, machine readable instructions stored in the memory 218 may be executed by the processor 215 to provide one or more of a variety of services and/or functionalities implemented and/or provided by the example mobile device 200 of FIG. 2. The memory 218 may contain any combination of random access memory (RAM) and/or read only memory (ROM). In particular, RAM may be implemented by dynamic random access memory (DRAM), Synchronous DRAM (SDRAM), and/or any other type of RAM device, and ROM may be implemented by flash memory and/or any other desired type of memory device.

In addition to handling receive and transmit data, the processor 215 may receive user inputs or selections, and/or provide a user interface for a user of the example mobile device 200. For example, the processor 215 may receive inputs and/or selections 220 made by a user via a keyboard 225, and provide a user interface on a display 230 (e.g., a liquid crystal display (LCD) 230) via, for instance, an LCD controller 235. Other example input devices include a touch screen, a mouse, etc. The display 230 may be used to display any of a variety of information such as, for example, menus, caller identification information, a picture, video, a list of telephone numbers, a list of video and/or audio channels, phone settings, etc.

To provide, for example, telephone services, the example device 200 includes any of a variety of voice coder-decoders (codecs) 240 and one or more of a microphone 245, a speaker 250 or a jack for a headset 255. In particular, the processor 215 can receive a digitized and/or compressed voice signal from the microphone 245 or the headset 255 via the voice codec 240, and then transmit the digitized and/or compressed voice signal via the RF transceiver 210 and the antenna 205 to a BTS. Likewise, the processor 215 can receive a digitized and/or compressed voice signal from the BTS and output a corresponding analog signal via, for example, the speaker 250 or headset 255 for listening by a user.

To allow the example mobile device 200 of FIG. 2 to determine the current location of the mobile device 200, the illustrated example of FIG. 2 includes a second antenna 260 and a positioning system receiver 265. Alternatively, the first antenna 205 may be used by the positioning system receiver 265. Using any of a variety of techniques, the positioning system receiver 265 receives signals transmitted by any variety of terrestrial and/or satellite positioning systems to calculate a current geographic location (i.e., a position fix) for the mobile device 200 and a current time of day. Examples include the United States (U.S.) Global Positioning System (GPS), the European Galileo System, and differential time-of-arrival (DTOA) systems and/or techniques. In an example, the processor 215 displays a map and the current location of the mobile device 200 on the display 230.

The processor 215 of the illustrated example executes machine readable instructions stored in, for instance, the memory 218, to determine the current location of the mobile device 200 and then reports the current location to the BTS to which the mobile device 200 is currently communicating. The processor 215 may periodically or aperiodically determine the current location of the device 200 and report the updated location to the BTS. Alternatively, the processor 215 may determine and report the current location in response to a query from the BTS.

In turn, a BTS of the illustrated example (e.g., an example BTS 300 discussed below in connection with FIG. 3) uses location information received from the mobile device 200 to determine one or more service parameters for the mobile device 200. For example, the BTS 300 may use the location information to determine if a user of the mobile device 200 is authorized to place and/or receive a phone call at the current location, to determine an audio and/or video channel of interest, etc. Other example service parameters abound such as, for instance, a billing rate (e.g., a cost to make the requested phone call), a service denial, a service feature enable (e.g., four digit dialing), service rate information, a service level, a service type, a media content stream, a media channel identifier, pushed content, etc. In general, the BTS 300 uses the identity of the mobile device 200 and the location information provided by the mobile device 200 to determine one or more service parameters related to any service currently ongoing and/or requested by the mobile device 200. For example, the BTS 300 may determine that the mobile device 200 has moved outside a zone for which the mobile device 200 is authorized to place and/or receive telephone calls and then either warn the user and/or disconnect the call.

Although an example wireless mobile device 200 has been shown in FIG. 2, wireless mobile devices may be implemented using any of a variety of other and/or additional devices, circuits, modules, etc. Further, the devices, circuits, modules, elements, etc. illustrated in FIG. 2 may be combined, re-arranged, and/or implemented in any of a variety of ways. For simplicity and ease of understanding, the following discussion references the example mobile device 200 of FIG. 2. However, persons of ordinary skill in the art will readily appreciate that the wireless virtual-network systems and methods to operate the same disclosed herein apply to any type of wireless mobile device that is able to use positioning system technologies to determine the current location of the mobile device and report the current location information to a BTS.

FIG. 3 illustrates an example manner of implementing a BTS 300. The example BTS 300 of FIG. 3 can simultaneously provide wireless services to a plurality of mobile devices (e.g., the example mobile device 200 of FIG. 2). To provide the wireless services, the example BTS 300 includes, among other things, an RF module 305 and a baseband module 315. As is conventional, the RF module 305 includes any of a variety of RF transceivers 307, wherein each RF transceiver 307 can transmit and/or receive wireless signals to and/or from one or more mobile devices via an antenna 320. Likewise, the baseband module 315 includes any of a variety of baseband processors 317. In general, each baseband processor 317 is paired with an RF transceiver 307 which is, in turn, paired with an antenna 320.

In the example of FIG. 3, data to be transmitted by the baseband module 315 and the RF module 305 is provided by a transport module 325. Data received by the RF module 305 and the baseband module 315 from a mobile device is provided to the transport module 325. The transmitted and received data may be associated with any of a variety of wireless services such as, for instance, a telephone call, an internet service, a messaging service, an audio service, a video service, etc.

In the illustrated example of FIG. 3, the wireless service data may be associated with any of a variety of service providers. For a telephone service, the wireless service data may be associated with a public switched telephone network (PSTN) 330. In an Internet or streaming video service, the wireless service data may be associated with a service provider 335 communicatively coupled to the transport module 325 via, for instance, the Internet 340. In general, the wireless service data may be associated with any variety of data sources and/or service providers communicatively coupled to the transport module 325. For instance, telephone data may alternatively be received from a voice over Internet (VoIP) service provider 335 via the Internet 340.

To transmit and/or receive the wireless service data from and/or to the data sources (e.g., the PSTN 330) and/or service providers (e.g., the service provider 335), the example transport module 325 of FIG. 3 includes one or more conventional interfaces 345 suitable for exchanging data with the data sources and/or service providers. To connect data from the interfaces 345 with the baseband module 315, the example transport module 325 includes any of a variety of switches 350. The switch 350 may be controlled using any of a variety of techniques to bi-directionally route data between the interfaces 345 and the baseband module 315. For example, the switch 350 may be configured to route a voice data channel between the PSTN 330 and a wireless service data channel associated with the baseband module 315 such that the voice data is transmitted to a particular mobile device.

To control and/or configure the example BTS 300 and to determine service parameters for wireless services, the example BTS 300 includes a service authorizer 355. The service authorizer 355 may be implemented using any of a variety of computing platforms (e.g., the example platform 8000 discussed below in connection with FIG. 8). In general, the service authorizer 355 receives wireless communication service requests from a mobile device via the baseband module 315 and/or from data sources and/or service providers via the interfaces 345, and determines if and/or how the wireless communication service may be provided. For example, the service authorizer 355 receives an incoming telephone call for a mobile device, and the service authorizer 355 and the baseband module 315 determine if the mobile device is reachable. If the mobile device is reachable, the service authorizer 355 configures the switch 350 to route the voice data to the mobile device. If the mobile device is not reachable, the service authorizer 355, for example, configures switch 350 to route the voice data to a voicemail server (not shown).

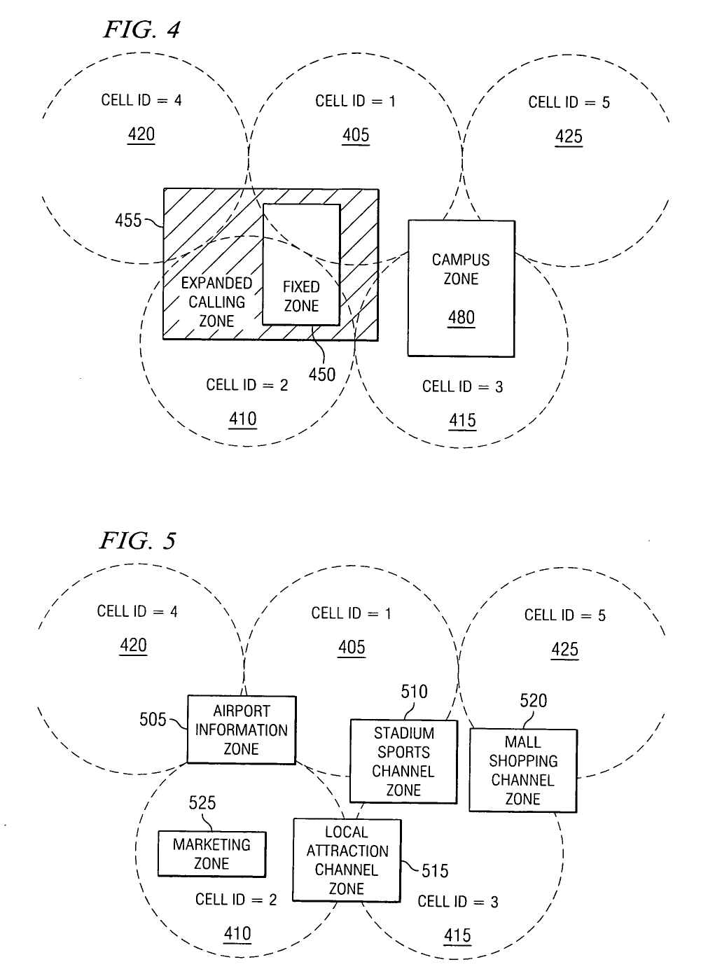

In the illustrated example, the service authorizer 355 uses location information determined by a mobile device (e.g., the example mobile device 200 of FIG. 2) to determine a service parameter associated with a requested wireless communication service. For example, as described below in connection with FIG. 4, the example service authorizer 355 determines if the mobile device 200 is located in an area for which the mobile device 200 is authorized to receive the requested wireless communication service (i.e., an authorization service parameter). In another example described below in connection with FIG. 5, a user of the mobile device 200 requests streaming text, audio and/or video describing local information. The BTS 300 uses the location information determined and provided by the mobile device 200 to determine if there is nearby local information available. If local information is available, the BTS 300 provides streaming media channel information or streaming text, audio and/or video data to the mobile device 200. Example local information may include: sports information near a sporting arena or venue; shopping information near a store, shopping center or mall; historical information near a historical site; plane arrival or departure information near an airport; etc. In the illustrated examples of FIGS. 3-5, the service authorizer 355 uses location information determined by the mobile device 200 to determine the service parameter rather than using a cell ID.

To store service information, service parameters, descriptions of service zones, information concerning mobile devices, etc., the example BTS 300 of FIG. 3 includes a database 360. The database 360 contains, among other things, geographic coordinates that defines service zones and stores service parameters associated with each service zone. Thus, the service authorizer 355 can compare the location of a mobile device 200 with the geographic coordinates of a service zone stored in the database 360. If the mobile device 200 is within the service zone, the service authorizer 355 can access the database 360 to determine the corresponding service parameter(s) for the service zone. Example service zones and associated service parameters are discussed below in connection with FIGS. 4 and 5. Each BTS 300 of the example wireless system of FIG. 1 may include the database 360, wherein the plurality of BTSs 300 communicate to ensure that each of the plurality of databases 360 remain consistent and coherent with each other. Alternatively, the BTS 300 may access a centrally located database 360 via, for example, the Internet 340, a private communication network and/or path (not shown), etc. The database 360 may be implemented using any of a variety of data structures and/or database elements.

FIG. 4 illustrates an example wireless virtual-network service scenario for an example wireless system. In the illustrated example of FIG. 4, the wireless system includes a plurality of BTSs which have coverage areas signified by the ovals with reference numerals 405, 410, 415, 420 and 425 in FIG. 4. Based upon coordinates that are not necessarily tied to the boundaries of the coverage areas 405-425, a plurality of service zones may be defined wherein each service zone defines a virtual wireless system within the entire wireless system illustrated in FIG. 4 (i.e., a wireless virtual-network system). In the examples of FIG. 2-6, the example service authorizer 355 uses service zone information stored in the database 360 together with location information determined by the example mobile device 200 of FIG. 2 via positioning system technologies, and reported by the mobile device 200 to the service authorizer 355, to know in which service zone(s), if any, a mobile device is currently located. As the service authorizer 355 receives additional location information from the mobile device, the service authorizer 355 may track the mobile device as it enters and/or leaves service zones thereby enabling, disabling and/or providing service information and/or parameters to a user of the mobile device and/or to the mobile device itself.

A first example fixed zone 450 is a service zone in which wireless telephone services are used as a replacement for land-line telephone services. For such services, it is desirable that the customer's mobile device (e.g., cellular telephone) only operate within a close proximity to the customer's residence or place of business. In particular, a user's cellular telephone only works while the customer's cellular telephone is located within the fixed zone 450 and, thus, the user's wireless telephone service is effectively fixed to within a small radius of their home or workplace. For instance, the service authorizer 355 of the illustrated example will deny an outgoing call request and/or block an incoming call if the customer's telephone is not located within the fixed zone 450, or will terminate an ongoing call if the customer's telephone leaves the fixed zone 450. As illustrated in FIG. 4, the fixed zone 450 may include a portion of more than one BTS coverage area (i.e., a portion of the areas 405 and 410). The fixed zone 450 may be larger or smaller than a single BTS coverage area.

The land-line replacement wireless service of the above example may offer an expanded service in a service area larger than the fixed zone 450. In particular, an expanded calling zone 455 may be defined that allows the customer a limited amount of roaming distance over which the customer's wireless telephone service continues operating. Telephone calls placed and/or received in the expanded calling zone 455 may be billed at a higher rate and/or may be included in a more expensive service package (i.e., in a tiered billing and/or tiered wireless communication services package). For example, the service authorizer 355 may notify the customer via the customer's phone as the customer crosses into or out of either the fixed zone 450 or the expanded calling zone 455, thereby allowing the customer to control their wireless communication service costs. Further, the service authorizer 355 may deny an outgoing call request and/or disconnect an ongoing call if the customer leaves the expanded calling zone 455. As illustrated in FIG. 4, service zones may overlap and, thus, a mobile device may currently be located in more than one service zone. In an example, when a mobile device is located in more than one service zone, the most beneficial service parameters are used (e.g., the service parameters that result in the lowest cost and/or greatest number of features for the consumer).

Service zones may also be used to enable advanced features for a subset of customers within a particular zone. For instance, example campus zone 480 may represent a business campus, an educational campus, etc. When a customer (e.g., an employee, a student, etc.) associated with the campus zone 480 (e.g., the business, the university, etc.) is located on the campus (i.e., within the campus zone 480), one or more advanced features may be enabled that are not available while the customer is outside the campus zone 480. For example, four digit dialing may be enabled within the campus zone 480; there may be no limit on the amount of services used within the campus zone 480 (i.e., total amount of talk time, etc.); higher speed services may be available within the campus zone 480; etc. As illustrated in FIG. 4, the campus zone 480 may include a portion of more than one BTS coverage area (i.e., a portion of the areas 405, 415 and 425) and the campus zone 480 may be larger or smaller than a single BTS coverage area. As with all service zones, the boundaries of the campus zone 480 need not be tied to the boundaries of any one or more of the BTS coverage areas 405-425.

FIG. 5 illustrates another example wireless virtual-network service scenario for the example wireless system of FIG. 1-3. FIG. 5 illustrates a plurality of information service zones that are not tied to boundaries of the coverage areas 405-425 of FIG. 4. In the example of FIG. 5, each information service zone represents a zone in which local information is available for reading, viewing and/or listening by a user of a mobile device. In particular, when a mobile device is located within one of the information service zones, the mobile device is able to receive the local information associated with that particular information service zone. In contrast, when the user is located outside a local information zone, the corresponding local information might not be available. As illustrated in the example of FIG. 5, the information service zones may include a portion of more than one BTS coverage area. Further, the information service zones may be larger or smaller than a single BTS coverage area.

In an example service, a customer with a mobile device (e.g., the example mobile device 200 of FIG. 2) requests local information from a BTS and provides a current location of the mobile device 200 to the BTS. The example service authorizer 355 (FIG. 3) uses service zone coordinates stored in the database 360 and the location information (i.e., the location information determined by the mobile device 200 via positioning system technologies and reported to the service authorizer 355) to know in which of the plurality of information service zones, if any, a mobile device 200 is currently located. If the mobile device 200 is within an information service zone, the service authorizer 355 either starts sending the local information to the mobile device 200 or informs the mobile device 200 of a media channel on which the location information is available. For example, the service authorizer 355 may notify the mobile device 200 that local information is available on video channel 16. The mobile device 200 may automatically tune to video channel 16 so that a user of the mobile device 200 may start viewing the local video information, or the user may be provided an opportunity to manually tune the noted channel.

Assuming, in the illustrated example, the service authorizer 355 receives additional location information from the mobile device 200, the example service authorizer 355 tracks the mobile device 200 as it enters and/or leaves information service zones. Upon determining a tracked mobile device exits, or enters a service zone, the example service authorizer 355 changes, starts, or stops the providing of the local information to the mobile device 200 and/or provides new media channel information to the mobile device 200.

FIG. 5 illustrates some example information service zones. For instance, an example airport information zone 505 provides streaming text-based arrival and/or departure information for persons near the airport. An example stadium sports channel zone 510 directs a mobile device 200 to a video and/or audio feed associated with an ongoing sporting event. An example local attraction channel zone 515 streams a video and/or audio stream providing information concerning a local attraction (e.g., a museum, etc.). An example mall shopping zone 520 automatically provides a store map of the mall to the mobile device 200. Of course, other example information service zones abound.

The example marketing service zone 525 of FIG. 5 may be used to collect market research data and/or to provide, for instance, targeted pushed content. In particular, the example BTS 300 may periodically or aperiodically push content to the mobile device 200. Example pushed content includes advertisements, offers to purchase, opportunities to donate, coupons, sales notifications, etc. A user of the mobile device 200 may respond to the pushed content by providing an input and/or selection to purchase a product, make a donation, apply a coupon, ignore the pushed content, etc. When such a response by the user is made, the processor 215 (FIG. 2) can use the positioning system receiver 265 to determine the current location of the mobile device 200 and then report to the BTS 300 the location along with the user's response to the pushed content.

Collected responses and the location information can then be used for market research purposes. For example, the information can be used to determine that certain types of purchases, donations, etc. are more likely to be made in certain marketing service zones and, thus, such marketing information can then be used to focus future pushed content in a more effective manner. For example, if users are more likely to make donations between 5-6 pm while riding the subway, a charitable organization can define a marketing service zone that includes a subway system and then push content to mobile devices as they enter the marketing zone between 5 pm and 6 pm that solicits a donation.

The mobile device 200 of the illustrated example periodically reports its current location to the BTS 300. The service authorizer 355 of the illustrated example then uses the location information to determine if the mobile device 200 has entered a marketing service zone. If the mobile device has entered a marketing service zone, the service authorizer 355 determines the pushed content (i.e., a service parameter) to be sent to the mobile device 200. Upon receipt of the pushed content, the mobile device 200 displays the content for the user.

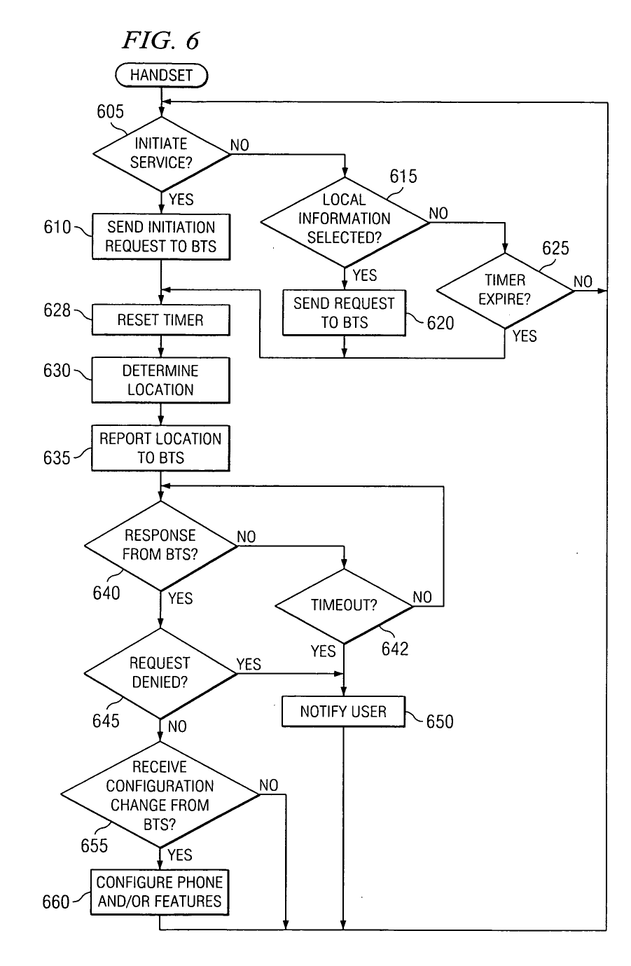

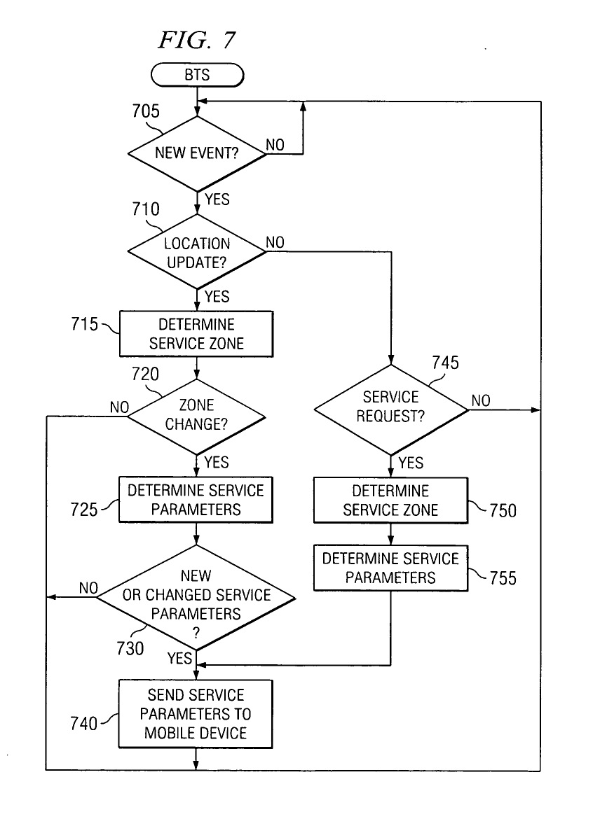

FIGS. 6 and 7 illustrate flowcharts representative of example machine readable instructions that may be executed to implement the example wireless virtual-network service scenarios illustrated in FIGS. 4 and 5 and/or, more generally, the example mobile device 200 of FIG. 2 and the example BTS 300 of FIG. 3, respectively. The example machine readable instructions of FIGS. 6 and 7 may be executed by a processor, a controller and/or any other suitable processing device. For example, the example machine readable instructions of FIGS. 6 and 7 may be embodied in coded instructions stored on a tangible medium such as a flash memory, or RAM associated with a processor (e.g., the processor 215 shown in the example media device 200 and discussed above in conjunction with FIG. 2, the example central processing unit 8010 discussed below in connection with FIG. 8, etc.). Alternatively, some or all of the example flowcharts of FIGS. 6 and 7 may be implemented using an application specific integrated circuit (ASIC), a programmable logic device (PLD), a field programmable logic device (FPLD), discrete logic, hardware, firmware, etc. Also, some or all of the example flowcharts of FIGS. 6 and 7 may be implemented manually or as combinations of any of the foregoing techniques, for example, a combination of firmware and/or software and hardware. Further, although the example machine readable instructions of FIGS. 6 and 7 are described with reference to the flowcharts of FIGS. 6 and 7, persons of ordinary skill in the art will readily appreciate that many other methods of implementing the example wireless virtual-network service scenarios illustrated in FIGS. 4 and 5 and/or, more generally, the example mobile device 200 of FIG. 2 and the example BTS 300 of FIG. 3, respectively, may be employed. For example, the order of execution of the blocks may be changed, and/or some of the blocks described may be changed, eliminated, sub-divided, or combined. Additionally, persons of ordinary skill in the art will appreciate that the example machine readable instructions of FIGS. 6 and 7 be carried out sequentially and/or carried out in parallel by, for example, separate processing threads, processors, devices, circuits, etc.

The example machine readable instructions of FIG. 6 begin with, for example, the processor 215 (FIG. 2) determining if a user has initiated a service request (block 605). Example requested services include making a telephone call, viewing an Internet site, receiving a video and/or audio stream, etc. The service request may be initiated by, for example, a user pressing a button on the keyboard 255 (FIG. 2), selecting a menu item displayed on the display 230 (FIG. 2), etc. If the user has initiated a service request (block 605), the processor 215 sends the initiation request via the RF transceiver 210 and the antenna 205 (FIG. 2) to a BTS (e.g., the example BTS 300 of FIG. 3) (block 610).

Returning to block 605, if a service request is not initiated, the processor 215 determines if the user has selected to receive local information and/or pushed content from a nearby information service zone or marketing service zone (block 615). If local information and/or pushed content is selected and/or enabled (block 615), the processor sends the request to the BTS 300 (block 620).

Returning to block 615, if neither a service request nor a request for local information and/or pushed content was selected, the processor 215 determines if a countdown timer has expired (block 625). If the count down timer has not expired (block 625) control returns to block 605.

If either the countdown timer has expired (block 625), a service request was sent (block 610) or a request for local information and/or pushed content was sent (block 620), the processor 215 resets the countdown timer (block 628). Using the positioning system receiver 265 (FIG. 2), the processor 215 determines the current location of the mobile device 200 (block 630) and reports the current location to the BTS 300 (block 635).

The processor 215 then waits to receive a response from the BTS 300 (block 640). Among other things, the response, as discussed above, includes one or more service parameters. If while waiting (block 640) a timeout occurs (block 642), the processor 215 notifies the user by, for example, displaying a message on the display 230 (block 650). Control then returns to block 605. If, based on the current location of the mobile device 200, a response received from the BTS 300 (block 640) indicates, via a service parameter, that the requested service is denied (block 645), the processor 215 notifies the user by, for example, displaying a message on the display 230 (block 650). Control then returns to block 605.

Returning to block 645, if the service request is not denied, the processor 215 determines if additional configuration service parameters are received (block 655). Example configuration service parameters include a media channel for local information, enabling advanced service features, a billing rate notification, pushed content, etc. If additional configuration service parameters are not received (block 655), control returns to block 605. If additional configuration service parameters are received (block 655), the processor 215 automatically configures the phone (e.g., completes and/or establishes a telephone call, tunes to a local information channel, enable four digit dialing, etc.) and/or displays a service message, pushed content and/or alert for the user (e.g., notifying the user of a higher billing rate, etc.) (block 660). Control then returns to block 605.

Alternatively or additionally, instead of using a countdown timer to determine when to determine the location of the mobile device 200, the processor 215 may determine and report the current location in response to a query from the BTS 300.

The example machine readable instructions of FIG. 7 begin with the example service authorizer 355 (FIG. 3) waiting to receive a new event such as, for example, a location update or a service request from a mobile device (e.g., the example mobile device 200 of FIG. 2) (block 705). When a new event occurs (block 705), the service authorizer 355 determines if a location update has been received from a mobile device 200 (block 710). Alternatively and/or additionally, the service authorizer 355 may periodically or aperiodically query the mobile device 200 for location information.

If a location update was received (block 710), the service authorizer 355 identifies the service zone in which the mobile device 200 is currently located based upon geographic coordinates of service zones stored in the database 360, the location information received from the mobile device 200 and the identity of the mobile device 200 (block 715). Example service zones include service zones related to wireless service authorization (e.g., land-line replacement), wireless service levels (e.g., tiered services), wireless service features (e.g., campus service zones), marketing service zones for pushed content, or information service zones for local information. The service authorizer 355 then determines if the mobile device 200 has entered and/or left a service zone (block 720). If no zone change has occurred (block 720), control returns to block 705 to wait for another new event.

If a zone change has occurred (i.e., the mobile device has entered a new service zone or exited a service zone) (block 720), the example service authorizer 355, using information stored in the database 360, determines one or more service parameters associated with the service zone that was entered or one or more changed service parameters due to leaving a service zone (block 725). If there are no new and/or changed service parameters (block 730), control returns to block 705 to await another new event. If there are new and/or changed service parameters (block 730), the service authorizer 355 sends the new and/or changed service parameters to the mobile device 200 via the baseband module 315 and the RF module 305 (FIG. 3) (block 740). Control then returns to block 705 to wait for another new event.

Returning to block 710, if a location update was not received, the service authorizer 355 determines if a service request was received (block 745). If a service request was not received (block 745), control returns to block 705 to wait for another new event. If a service request was received (block 745), the service authorizer 355 determines in which, if any, service zone the mobile device 200 is currently located (block 750). Based upon the determined service zone and information stored in the database 360, the example service authorizer 355 determines one or more service parameters for the requested service and/or the determined service zone (block 755). The service authorizer 355 sends the service parameters to the mobile device via the baseband module 315 and the RF module 305 (block 740). Control then returns to block 705 to wait for another new event.

FIG. 8 is a schematic diagram of an example processor platform 8000 that may be used and/or programmed to carry out the example machine readable instructions illustrated in FIGS. 6 and 7 to implement the example wireless virtual-network service scenarios illustrated in FIGS. 4 and 5 and/or, more generally, the example mobile device 200 of FIG. 2 and the example BTS 300 of FIG. 3, respectively. For example, the processor platform 8000 can be implemented by one or more general purpose microprocessors, microcontrollers, etc.

The processor platform 8000 of the example of FIG. 8 includes a general purpose programmable processor 8010. The processor 8010 executes coded instructions 8027 present in main memory of the processor 8010 (e.g., within a random access memory (RAM) 8025). The processor 8010 may be any type of processing unit, such as a DSP from the TI® family of DSP, an OMAP® processor from TI, an ARM processor, or any of a variety of microprocessor. The processor 8010 may carry out, among other things, the example machine readable instructions illustrated in FIGS. 6 and 7.

The processor 8010 is in communication with the main memory (including a ROM 8020 and the RAM 8025) via a bus 8005. The RAM 8025 may be implemented by DRAM, SDRAM, and/or any other type of RAM device. The ROM 8020 may be implemented by flash memory and/or any other desired type of memory device. Access to the memory 8020 and 8025 is typically controlled by a memory controller (not shown) in a conventional manner.

The processor platform 8000 also includes a conventional interface circuit 8030. The interface circuit 8030 may be implemented by any type of well-known interface standard, such as an external memory interface, serial port, general purpose input/output, etc.

One or more input devices 8035 and one or more output devices 8040 are connected to the interface circuit 8030. The input devices 8035 and output devices 8040 may be used, for example, to implement interfaces between the service authorizer 355 and the switch 350 and/or the baseband module 315.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
receiving a positioning system signal identifying a location of a mobile device;
determining a service zone for the mobile device by comparing the location to a database identifying geographic locations of service zones; and
determining a service parameter for the mobile device based upon the service zone.

2. A method as defined in claim 1, wherein the service zone is at least one of a campus zone, a fixed zone, an expanded calling zone, a marketing service zone, a broadcast service zone, or a local information zone.

3. A method as defined in claim 1, wherein the service parameter is at least one of a service authorization, a denial of a service request, a service feature, service rate information, a billing rate, a service level, a service type, pushed content, a media content stream, or a media channel identifier.

4. A method as defined in claim 1, further comprising requesting the location of the mobile device.

5. A method as defined in claim 1, further comprising transmitting the service parameter to the mobile device.

6. A method as defined in claim 1, further comprising:
receiving a second positioning system signal identifying a second location of the mobile device;
determining if a service zone change has occurred by comparing the location to the database identifying geographic locations of service zones;
if a service zone changed has occurred, determining a second service parameter based upon the service zone change; and
transmitting the second service parameter to the mobile device.

7. An apparatus comprising:
a database mapping service parameters to geographic locations;
a service authorizer to receive location information from a mobile device and to access the database to determine a service parameter associated with the mobile device based upon the location information, wherein the location information is obtained via a positioning system receiver associated with the mobile device; and
a baseband module to communicate the service parameter to the mobile device via a wireless signal.

8. An apparatus as defined in claim 7, wherein the service authorizer accesses the database to determine a service zone based on the location, and accesses the database to determine the service parameter based on the service zone.

9. An apparatus as defined in claim 7, further comprising an interface to receive service information from a service provider, wherein the service authorizer uses the service information and the location information to set the service parameters in the database.

10. An apparatus as defined in claim 7, further comprising a radio frequency (RF) module, wherein an output signal of the baseband module is processed by the RF module to communicate the service parameter to the mobile device.

11. An apparatus as defined in claim 7, wherein the service authorizer uses the baseband module to receive the location information from the mobile device.

12. A method comprising:
determining a location with a positioning system receiver;
sending a service request and an identification of the location to a wireless basestation transceiver subsystem (BTS); and
receiving a service parameter associated with the service request from the BTS, wherein the service parameter is determined based upon the location.

13. A method as defined in claim 12, wherein sending the location is performed periodically.

14. A method as defined in claim 12, further comprising receiving a changed service parameter.

15. An article of manufacture storing machine readable instructions which, when executed, cause a machine to:
receive a positioning system signal identifying a location of a mobile device;
determine a service zone for the mobile device by comparing the location to a database identifying geographic locations of service zones; and
determine a service parameter for the mobile device based upon the service zone.

16. An article of manufacture as defined in claim 15, wherein the service zone is at least one of a campus, a fixed zone, an expanded calling zone, a marketing service zone, a broadcast service zone, or a local information zone.

17. An article of manufacture as defined in claim 15, wherein the service parameter is at least one of an authorization for a service, a denial of a service request, a service feature, service rate information, a billing rate, a service level, a service type, pushed content, a media content stream, or a media channel identifier.

18. An article of manufacture as defined in claim 15, wherein the machine readable instructions, when executed, cause the machine to:
receive a second positioning system signal identifying a second location of the mobile device;
determine if a service zone change has occurred by comparing the location to the database identifying geographic locations of service zones;
if a service zone changed has occurred, determine a second service parameter based upon the service zone change; and
transmit the second service parameter to the mobile device.

19. A method comprising:
providing a plurality of cells in a wireless network, each of the cells corresponding to a respective service area associated with a wireless basestation transceiver subsystem (BTS); and
associating a geographic area with a service zone, wherein the geographic area of the service zone is not coextensive with any of the cells of the network.

20. A method as defined in claim 19, wherein the geographic area of the service zone overlaps at least two of the cells.

21. A method as defined in claim 19, wherein the geographic area of the service zone is located within one of the cells.

22. A method as defined in claim 19, further comprising associating a service parameter with the service zone

23. A method as defined in claim 22, wherein the service parameter is at least one of a service authorization, a denial of a service request, a service feature, service rate information, a billing rate, a service level, a service type, pushed content, a media content stream, or a media channel identifier.

24. A method as defined in claim 22, further comprising:
determining that a mobile device is located in the service zone; and
transmitting the service parameter associated with the service zone to the mobile device.
